(19) United States
(12) Patent Application Publication
(10) Pub. No.: US 2025/0132091 A1
(43) Pub. Date: Apr. 24, 2025

(54) METHOD AND MACHINE TO MANUFACTURE AT LEAST TWO DIFFERENT COILS AROUND A COMPONENT OF AN ARTICLE

(71) Applicant: G.D. SOCIETA' PER AZIONI, Bologna (IT)

(72) Inventor: Fulvio Boldrini, Bologna (IT)

(21) Appl. No.: 18/682,269

(22) PCT Filed: Aug. 5, 2022
(86) PCT No.: PCT/IB2022/057298

§ 371 Date: Feb. 8, 2024

(30) Foreign Application Priority Data
Aug. 11, 2021 (IT) 102021000021725

(51) Int. Cl. H01F 41/06

(52) U.S. Cl. CPC H01F 41/06

(57) ABSTRACT

Method and machine (18) to manufacture at least two different coils (9-14) around a component (1) of an article. The method comprises: moving, by means of a main conveyor (19) and along a winding path (P), a carriage (20) carrying at least one seat (22, 23, 24) designed to house the component (1); placing, in an input station (SI) arranged along the winding path (P), the component (1) in the seat (22, 23, 24) of the carriage (20); winding, in a first winding station (S3) arranged along the winding path (P) downstream of the input station (SI), a first externally insulated conductor wire (15) around the component (1) in order to obtain a series of turns making up a first coil (9-14); and winding, in a second winding station (S6) arranged along the winding path (P) downstream of the first winding station (S3), a second externally insulated conductor wire (15) around the component (1) in order to obtain a series of turns making up a second coil (9-14); and changing, in a first handling station (S5) arranged along the winding path (P) between the first winding station (S3) and the second winding station (S6), the orientation of the component (1) relative to the carriage (20).

### CROSS-REFERENCE TO RELATED APPLICATIONS

This Patent Application claims priority from Italian Patent Application No. 102021000021725 filed on Aug. 11, 2021, the entire disclosure of which is incorporated herein by reference.

### TECHNICAL SECTOR

The invention relates to a method and a machine to manufacture at least two different coils around a component of an article.

The invention finds advantageous application on the tobacco industry to manufacture an electronic component of a disposable cartridge of an electronic cigarette, to which explicit reference will be made in the description below without because of this losing in generality.

### PRIOR ART

An electronic cigarette normally comprises a re-usable part, which is used several times and contains, among other things, an electric battery (which provides the power needed for the operation of the electronic cigarette) and an electronic processor, which controls the operation of the electronic cigarette. Furthermore, the electronic cigarette comprises a disposable cartridge (namely to be used one single time and to be then replaced), which is coupled to the re-usable part.

Recently, a disposable cartridge was developed, which is provided with a transponder equipped with a memory where the features of the disposable cartridge are stored, in particular the features of the (liquid or solid) active substance that has to heated in order to release the vapours to the inhaled; in this way, the re-usable part of the electronic cigarette can read the features of the disposable cartridge coupled thereto, accordingly adjusting the heating to the features of the disposable cartridge.

In most applications, the transponder comprises one single wound antenna (namely, one single coil serving as antenna); however, in some applications, the transponder can comprise a plurality of antennas (namely, a plurality of coils serving as antennas), which have different spatial orientations so as to make sure that the transponder is capable of effectively communicating in all possible positions.

### DESCRIPTION OF THE INVENTION

The object of the invention is to provide a method and a machine to manufacture at least two different coils around a component of an article, said method and said machine allowing users to operate at a high operating speed (measured as number of components produced per time unit), ensuring, at the same time, a high productive quality (generally measured as percentage of faulty pieces).

According to the invention there are provided a method and a machine to manufacture at least two different coils around a component of an article as claimed in the appended claims.

The appended claims describe preferred embodiments of the invention and form an integral part of the description.

### BRIEF DESCRIPTION OF THE DRAWINGS

The invention will now be described with reference to the accompanying drawings showing a non-limiting embodiment thereof, wherein:

FIGS. 1 and 2 are two different perspective views of a component of a disposable cartridge of an electronic cigarette;

FIG. 3 is a schematic front view of a machine producing the component of FIGS. 1 and 2 and manufactured according to the invention;

FIG. 4 is a perspective view, with parts removed for greater clarity, of the machine of FIG. 3;

FIG. 5 is a perspective view of a carriage of a main conveyor of the machine of FIG. 3;

FIGS. 6 and 7 are two different perspective views, with parts removed for greater clarity, of a support plate of the carriage of FIG. 5;

FIG. 8 is a perspective view, with parts removed for greater clarity, of an input station of the machine of FIG. 3;

FIGS. 9-12 are respective perspective views, with parts removed for greater clarity, of a winding station of the machine of FIG. 3;

FIG. 13 is a perspective view, with parts removed for greater clarity, of a welding station of the machine of FIG. 3; and

FIGS. 14-18 are respective perspective views, with parts removed for greater clarity, of corresponding handling stations of the machine of FIG. 3.

### PREFERRED EMBODIMENTS OF THE INVENTION

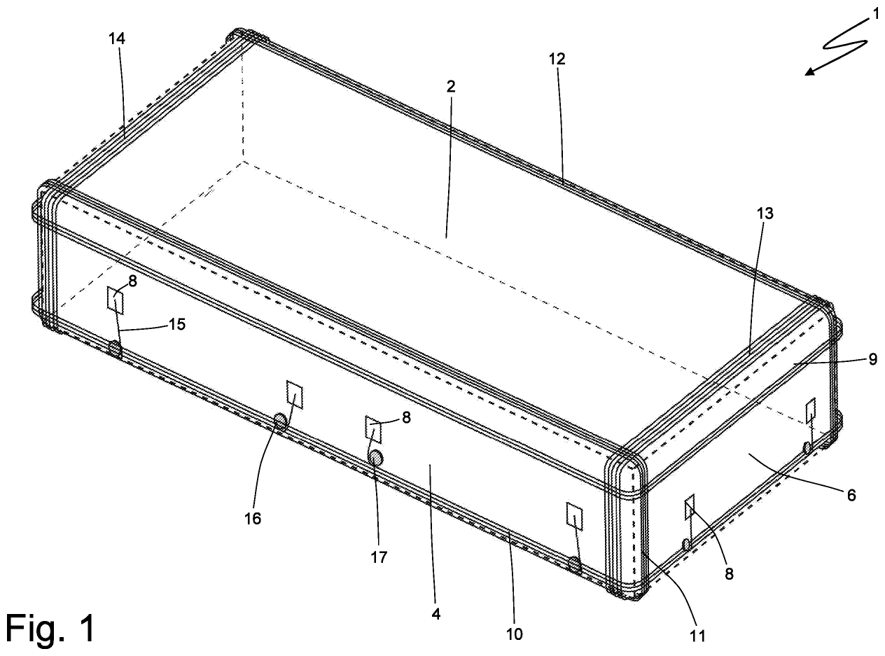

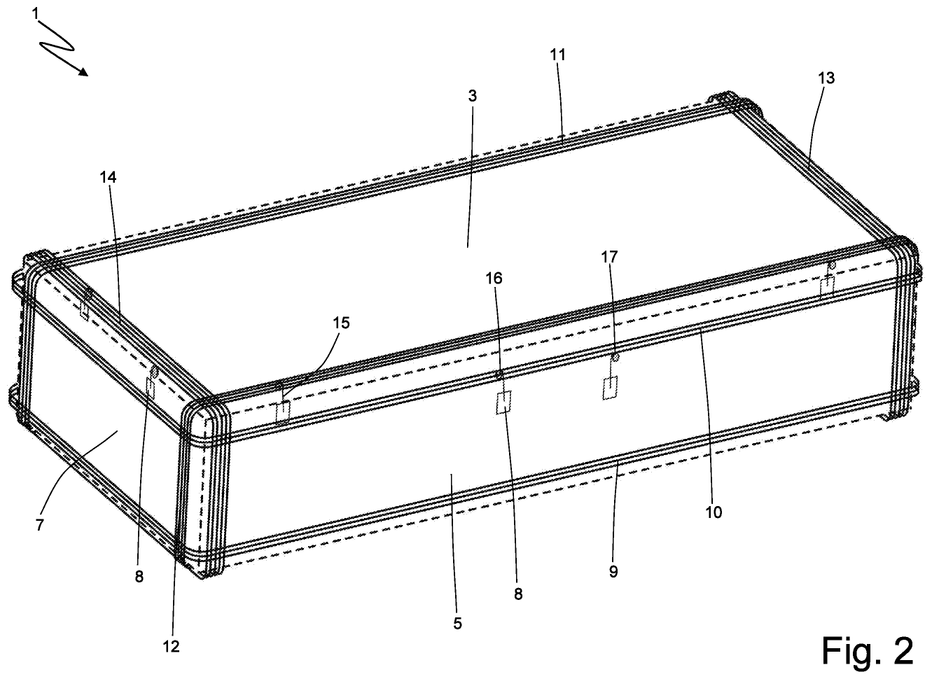

In FIGS. 1 and 2, reference number 1 indicates, as a whole, a component of a disposable cartridge of an electronic cigarette.

The component 1 approximately has the shape of a parallelepiped having six walls (faces): an upper wall 2, a lower wall 3, which is parallel to and opposite the upper wall 2, a front wall 4, a rear wall 5, which is parallel to an opposite the front wall 4, and two side walls 6 and 7, which are parallel to and opposite one another.

The component 1 comprises an integrated electronic circuit (not shown), which is arranged inside the component, is generally provided with an electric battery of its own (namely, has a power source of its own) and has six pairs of electrical contacts 8, which are arranged in the area of the walls 4-7: a pair of electrical contacts 8 is arranged in the area of the side wall 6, two pairs of electrical contacts 8 are arranged in the area of the front wall 4, a pair of electrical contacts 8 is arranged in the area of the side wall 7, and two pairs of electrical contacts 8 are arranged in the area of the rear wall 5.

Furthermore, the component 1 comprises six coils 9-14, which are wound: two coils 9 and 10 with a larger size (area), which surround the walls 4-7 and are arranged at the opposite ends of the component 1 (namely, the coil 9 is arranged close to the upper wall 2, whereas the coil 10 is arranged close to the lower wall 3), two coils 11 and 12 with an intermediate size (area), which surround the walls 2-3 and 6-7 and are arranged at the opposite ends of the component 1 (namely, the coil 11 is arranged close to the front wall 4, whereas the coil 12 is arranged close to the rear wall 5), and two coils 13 and 14 with a smaller size (area), which surround the walls 2-5 and are arranged at the opposite ends of the component 1 (namely, the coil 13 is arranged close to the side wall, 6 whereas the coil 14 is arranged close to the side wall 7).

Each coil 9-14 is wound and consists of a plurality of turns of an externally insulated conductor wire 15, which form a winding; in the embodiment shown in the accompanying figures there are approximately 10-15 turns. Each coil 9-14 (namely, the wound wire 15 making up each coil 9-14) has two ends (obviously, an initial end and a final end depending on the winding direction), which are welded to a corresponding pair of electrical contacts 8.

The electronic circuit of the component 1 uses the six coils 9-14 in an alternative or simultaneous manner in order communicate, through radio frequency, with other electronic devices arranged nearby. Alternatively or in addition, the electronic circuit of the component 1 could also use the six coils 9-14 to generate power (used for its own operation and/or to charge its own electric battery) exploiting an electromagnetic field generated by an electronic device arranged nearby; namely, the electronic circuit of the component 1 could also use the six coils 9-14 to carry out an inductive (namely contact-less) power charging of its own electric battery. As a consequence, the six coils 9-14 of the component 1 constitute corresponding antennas, which can be used to exchange information by means of electromagnetic waves (in this case, the antennas are part of a telecommunication device) and/or can be used to exchange power by means of electromagnetic waves (in this case, the antennas are part of a charging device).

Finally, the component 1 comprises six pairs of pins 16 and 17 (namely, two small columns), which protrude in a projecting manner (namely, perpendicularly) from the corresponding walls 2-7 and are arranged close to corresponding pairs of electrical contacts 8; the two (initial and final) ends of the wound wire 15 making up each coil 9-14 are bent by (circa) 90° around the corresponding pins 16 or 17 before being fitted into the electrical contacts 8 (namely, before reaching the corresponding electrical contacts 8 to which the two ends are welded).

It should be pointed out that the position and the shape of the electrical contacts 8 and of the pins 16 and 17 could be completely different, provided that each coil 9-14 is associated with two respective electrical contacts 8 and two respective pins 16 and 17 and that the pins 16 and 17 are arranged (relatively) close to the electrical contacts 8.

In the embodiment shown in the accompanying figures, the component 1 comprises six coils 9-14; according to other embodiments, which are not shown herein, the component 1 has a different number of coils 9-14, which generally ranges from two to five (but, in some cases, there can even be more than six coils 9-14).

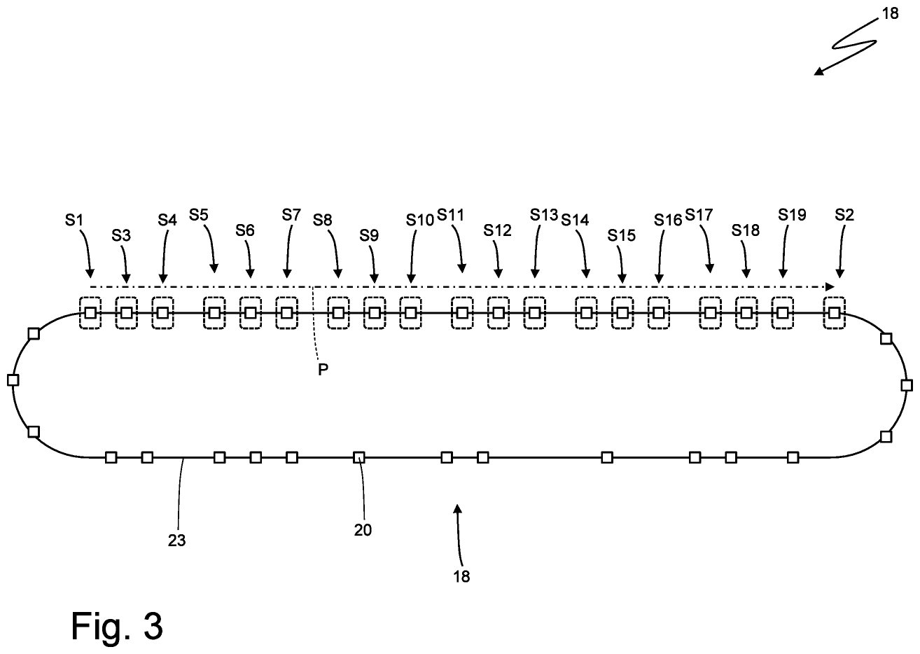

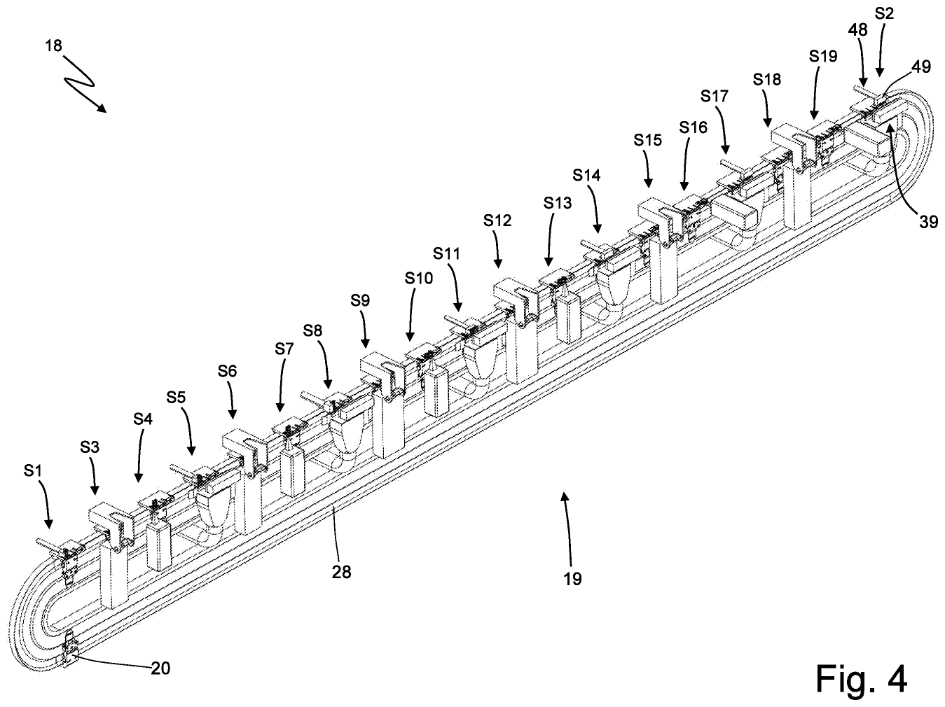

In FIGS. 3 and 4, reference number 18 indicates, as a whole, a machine to manufacture the coils 9-14 in the component 1.

The machine 18 comprises a support body (namely, a frame), which rests on the ground by means of legs and has, at the front, a vertical wall on which the operating members are mounted. Furthermore, the machine 18 comprises a main conveyor 19, which moves the components 1 being processed along a winding path P, which develops between an input station S1 (where the main conveyor 19 receives the components 1 to be provided with the coils 9-14) and an output station S2 (where the main conveyor 19 releases the complete components 1, namely provided with the coils 9-14).

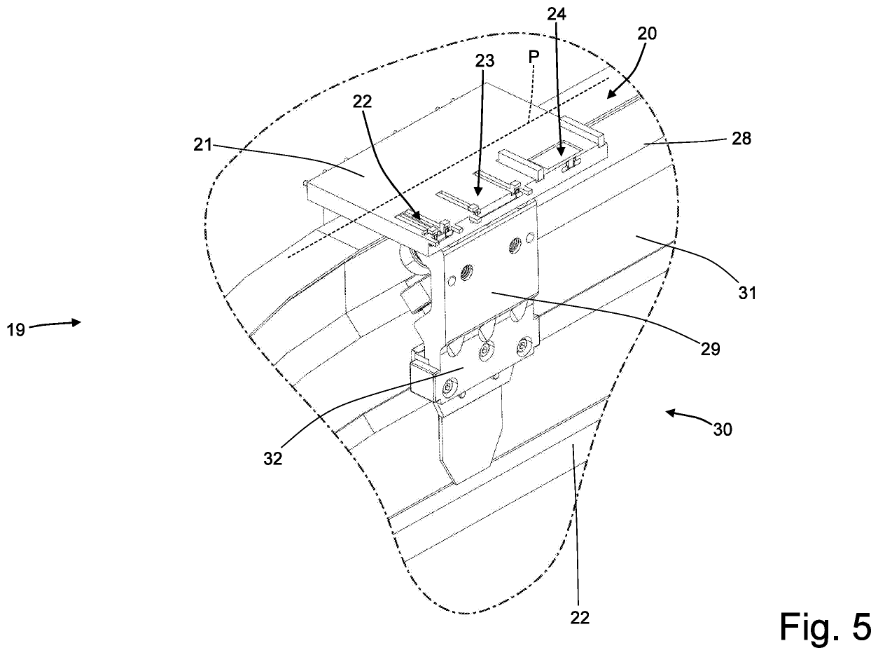

The winding path P goes through a series of stations S3-S19 (better described below), where the operations for manufacturing the six coils 9-14 are carried out. In the embodiment shown in the accompanying figures, the main path P comprises one single horizontal and linear segment (namely, substantially developing along a straight line arranged horizontally) arranged between the input station S1 and the output station S2; according to a different embodiment, which is not shown herein, the winding path P comprises: an upper segment, which is horizontal and linear, a lower segment, which is horizontal and linear (and, hence, is parallel to the upper segment), and a semicircular joining segment, which connects the upper segment and the lower segment to one another. The main conveyor 19 comprises a plurality of carriages 20, which are moved along the winding path P; as better shown in FIGS. 5, 6 and 7, each carriage 20 comprises a support plate 21, in which three different seats 22, 23 and 24 are obtained, each designed to receive and house the same component 1 with different orientations. Namely, the seat 22 is designed to accommodate the component 1 when the side wall 6 or the side wall 7 of the component 1 rests on the support plate 21, the seat 23 is designed to accommodate the component 1 when the front wall 4 or the rear wall 5 of the component 1 rests on the support plate 21, and the seat 24 is designed to accommodate the component 1 when the upper wall 2 or the lower wall 3 of the component 1 rests on the support plate 21. Hence, each support plate 21 is suited to support one single component 1, which can be arranged with three different orientations and in six different positions (each orientation entails two different positions).

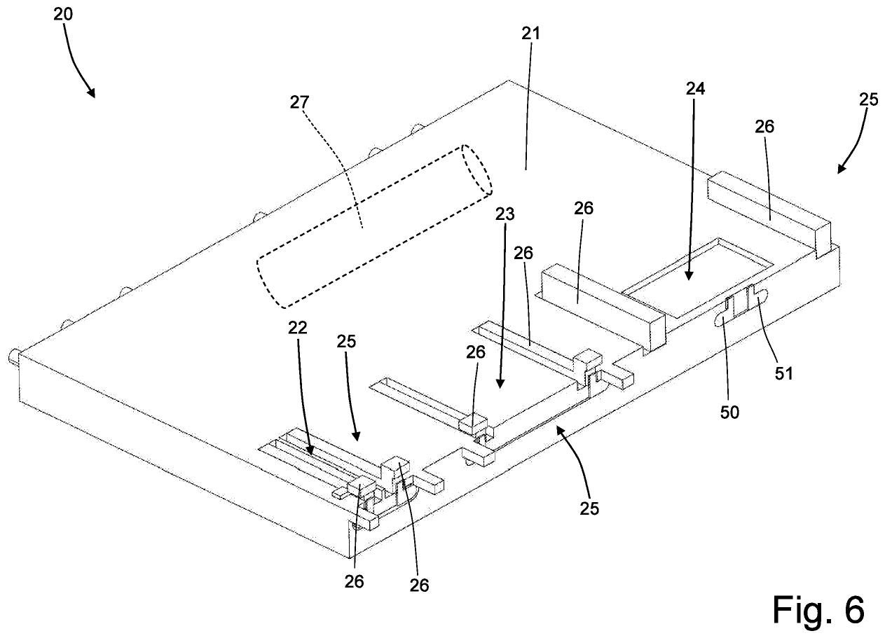

According to a preferred embodiment, which is better shown in FIG. 6, each seat 22, 23 or 24 comprises a clamp 25, which is closed to firmly hold a component 1 resting on the support plate 21 and is opened to release a component 1 resting on the support plate 21. Each clamp 25 comprises two opposite jaws 26, which are arranged at the opposite ends of the seat 22, 23 or 24, are movable by means of a linear movement (which develops parallel to the winding path P) and, in use, move between a holding position, in which the two jaws 26 are closer to one another and clamp a component 1 resting on the support plate 21, and a release position, in which the two jaws 26 are farther from one another and release a component 1 resting on the support plate 21. The clamps 25 are all controlled together by a same actuator device 27 (namely, all three clamps 25 open and close at the same time), which can be mounted on the support plate 21 or can be on the outside of the support plate 21 and be arranged in a fixed position beside the main conveyor 19. Preferably, each clamp 25 normally is closed, namely, in the absence of an intervention of the actuator device 27, it naturally remains closed; this result is obtained thanks to the presence of a spring, which tends to push the jaws 26 of each clamp 25 towards the closed position and is compressed by the action of the actuator device 27 (namely, the actuator device 27 must overcome the elastic force generated by the spring in order to move the jaws 26 of each clamp 25 towards the open position). According to a different embodiment, each clamp 25 has an actuator device 27 of its won, which is separate from and independent of the actuator devices 27 of the other two clamps 25; in this way, each actuator device 27 is optimized for the stroke of the jaws 26 of the corresponding clamp 25.

It should be pointed out that the three clamps 25 of the three seats 22, 23 and 24 of a same support plate 21 are the same from a functional point of view (namely, they are all designed to grab and hold the component 1 in three different positions), but they could be different from a structural point of view (namely, have different shapes) in order to adjust themselves to the conformation of the component 1.

Obviously, the number of seats 22 obtained in the support plate 21 of each carriage 20 could be other than three depending on the number of coils 9-14 to be manufactured and on the conformation of the component 1; hence, the support plate 21 of each carriage 20 could have one single seat 22, 23 or 24 or two seats 22, 23 or 24 or even more than three seats 22, 23 or 24.

The main conveyor 19 is designed to cyclically move each carriage 20 along the winding path P with an intermittent (step-like) movement, which entails cyclically alternating movement phases, in which the main conveyor 19 moves the carriages 20, and stop phases, in which the main conveyor 19 holds the carriages 20 still. According to FIG. 5, the main conveyor 19 comprises an annular guide 28 (namely, closed on itself with a ring shape), which is arranged in a fixed position along the winding path P; in particular, the annular guide 28 consists of one single fixed track (namely, without movement), which is arranged along the winding path P. Furthermore, the main conveyor 19 comprises a plurality of slides 29, each supporting a corresponding carriage 20 and being coupled to the guide 28 so as to freely slide along the guide 28. Finally, the main conveyor 19 comprises a linear electric motor 30, which moves the slides 29 carrying the carriages 20 along the winding path P; furthermore, the linear electric motor 20 comprises an annular stator 31 (namely, a fixed primary element), which is arranged in a fixed position along the guide 28, and a plurality of movable sliders 32 (namely, movable secondary elements), each electrically-magnetically coupled to the stator 31 so as to receive, from the stator 31, a driving force and rigidly connected to a corresponding slide 29.

According to a different embodiment, which is not shown herein, the main conveyor 19 is a conveyor belt and comprises (at least) a flexible belt, which supports the carriages 20 and is closed in a ring shape around at least two end pulleys (at least one of them being motor-driven). According to a further embodiment, which is not shown herein, the main conveyor 19 is a drum (arranged in a vertical horizontal manner), which is mounted so as to rotate around a central rotation axis; obviously, in this embodiment, the winding path P has a circular shape.

In the description below, the functions of the stations S1-S19 of the machine 18 will be explained with reference to one single carriage 20 moving one single component 1.

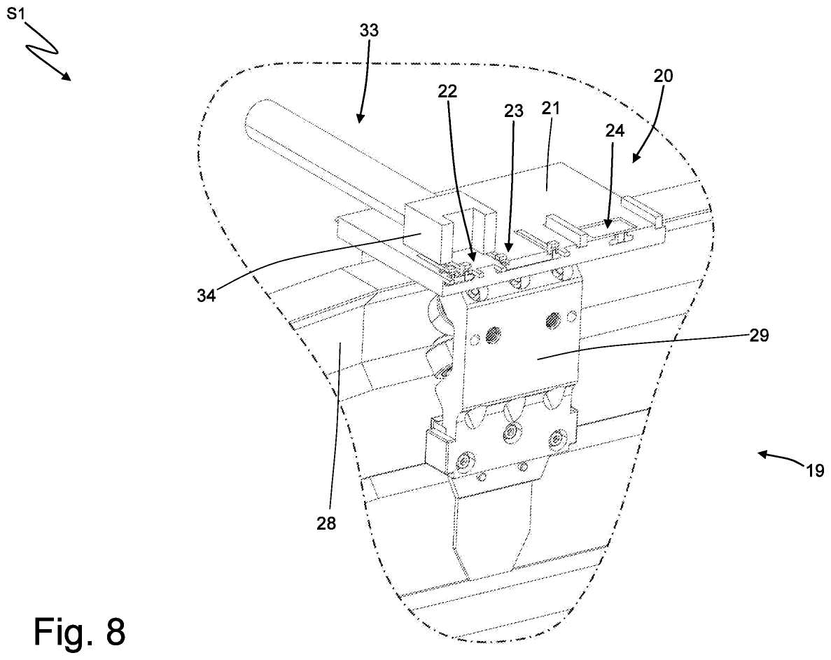

According to FIGS. 3 and 4, at the beginning of the manufacturing cycle of the coils 9-14, the main conveyor 19 moves the carriage 20 (carrying three seats 22 to be used alternatively) along the winding path P so as to stop one single carriage 20 in the input station S1, in which one single component 1 is placed in the seat 22 of the carriage 20 by laying the side wall 6 on the support plate 21 (namely, with the side wall 7 arranged horizontally and in the highest point). According to FIG. 8, in the input station S1 there is a motor-driven arm 33 provided with a holding head 34, which is designed to grab the component 1 holding it on part of the walls 4 and 5 (namely, leaving the side walls 6 and 7 completely free); when the carriage 20 is standing still in the input station S1, the motor-driven arm 33 inserts a component 1 in the seat 22 of the carriage 20 by laying the side wall 6 on the support plate 21.

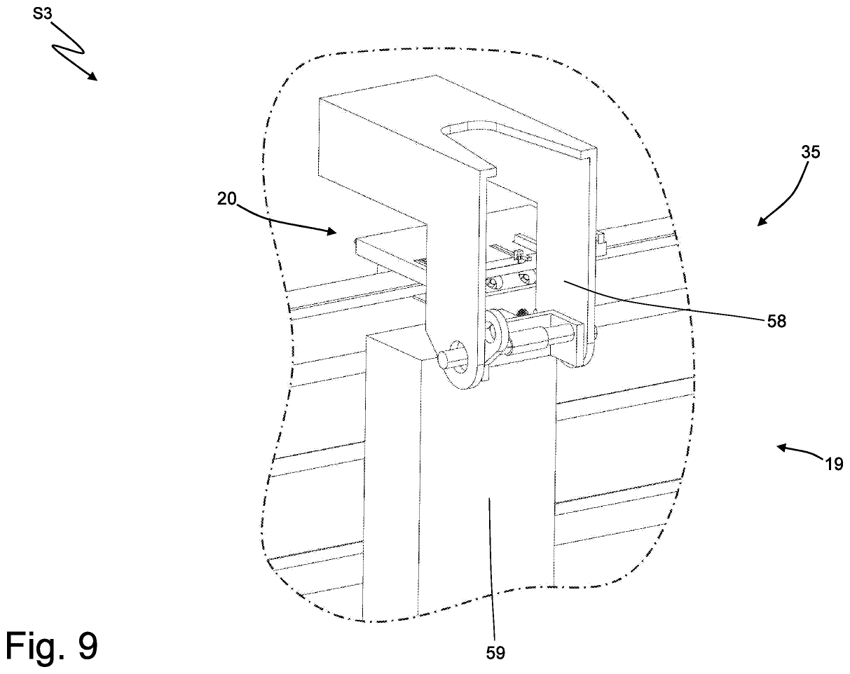

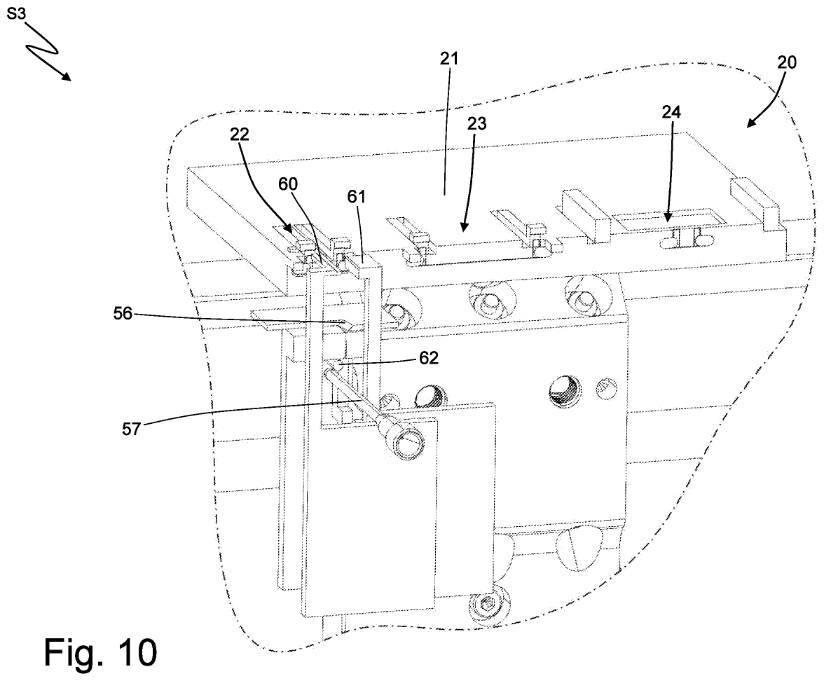

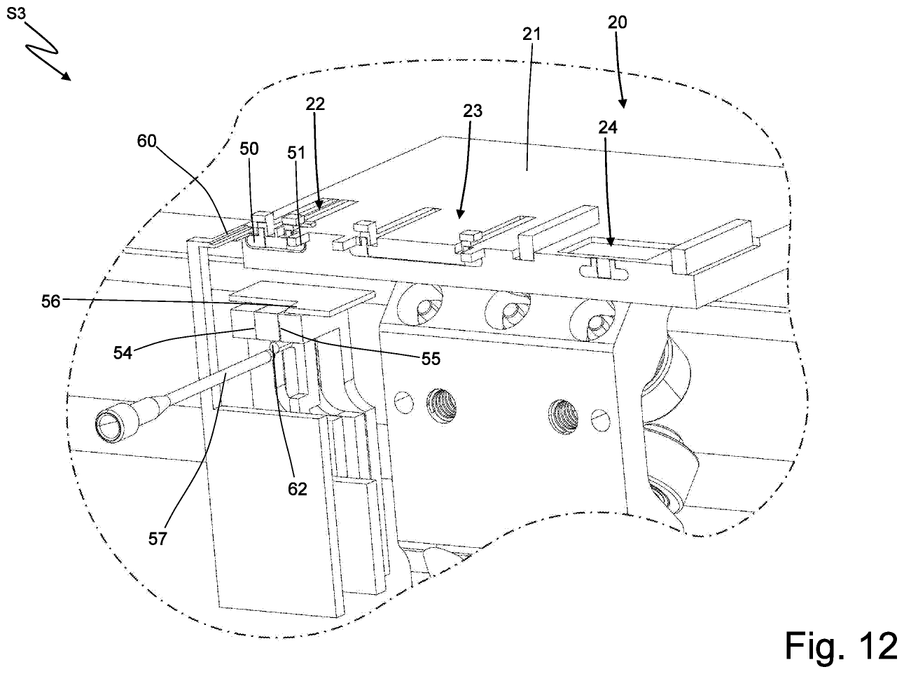

Subsequently, the main conveyor 19 moves the carriage 20 (carrying one single component 1 in its own seat 22) along the winding path P and from the input station S1 to the winding station S3, in which the carriage 20 stops and in which a winding unit 35 (which is shown more in detail in FIGS. 9-12) winds an externally insulated conductor wire 15 around the component 1 carried by the carriage 20 in order to obtain a series of turns making up the coil 14.

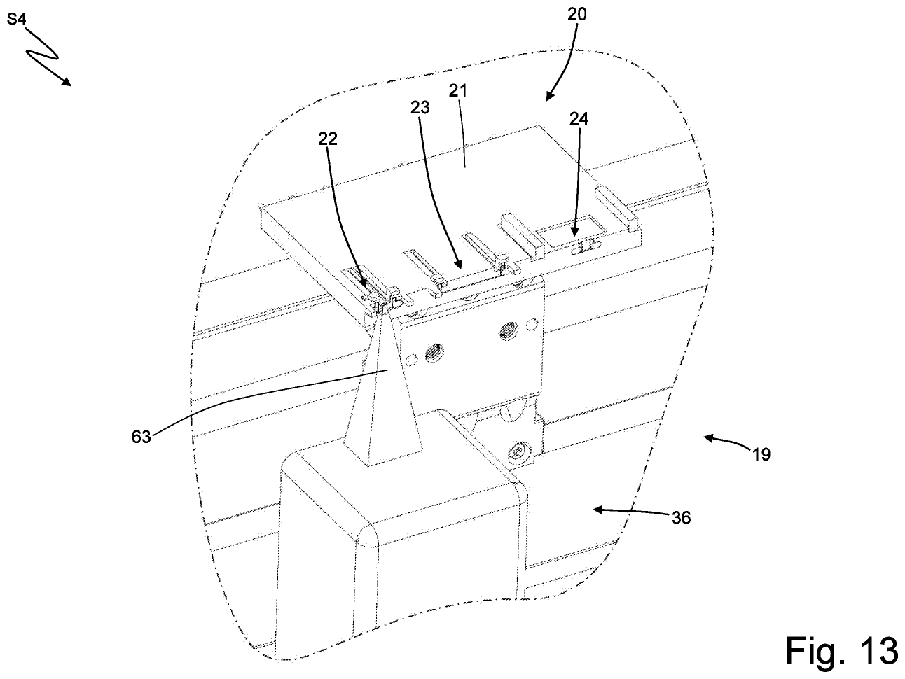

Subsequently, the main conveyor 19 moves the carriage 20 (carrying one single component 1 in its own seat 22) along the winding path P and from the winding station S3 to the welding station S4 (arranged downstream of the winding station S3), in which the carriage 20 stops and in which the two opposite ends of the coils 14, which was wound in the previous winding station S3, are welded (for example, through ultrasounds, through heat sealing or through laser) to the two corresponding electrical contacts 8 by a welding unit 36 (shown more in detail in FIG. 13).

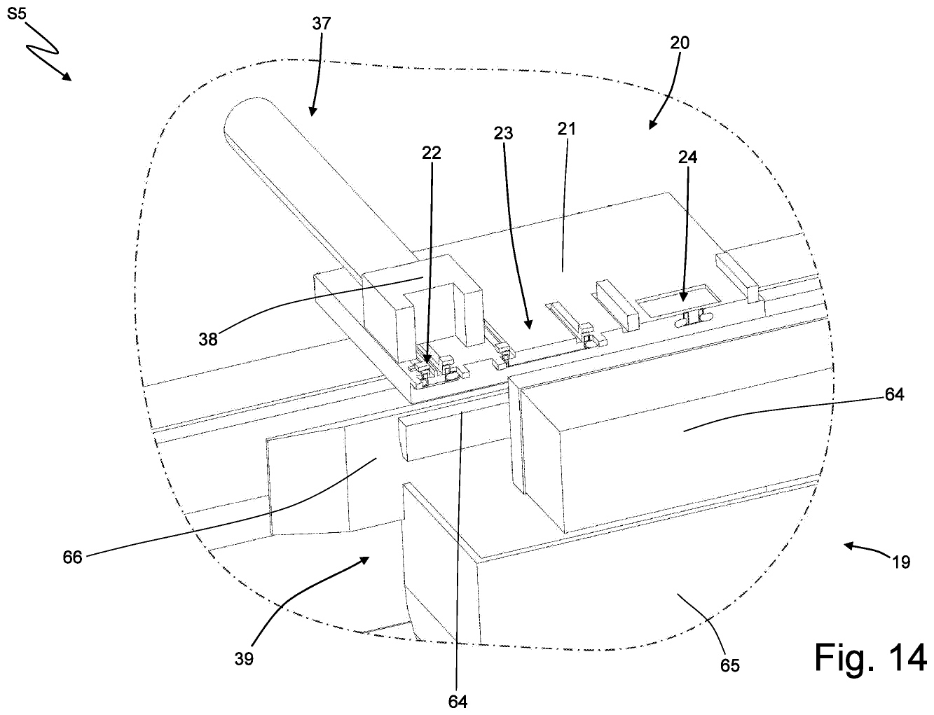

Subsequently, the main conveyor 19 moves the carriage 20 (carrying one single component 1 in its own seat 22) along the winding path P and from the welding station S4 to the handling station S5 (arranged downstream of the welding station S4), in which the carriage 20 stops and in which the component 1 is turned upside-down (namely, rotated around itself by 180°) in order to be placed in the seat 22 of the carriage 20 by laying the side wall 7 on the support plate 21 (namely, with the side wall 6 arranged horizontally and in the highest point). According to FIG. 14, in the handling station S5 there is a motor-driven arm 37 provided with a holding head 38, which is designed to grab the component 1 holding it on part of the walls 4 and 5 (namely, leaving the side walls 6 and 7 completely free); when the carriage 20 is standing still in the handling station S5, the motor-driven arm 37 grabs the component 1 standing in the seat 22 of the carriage 20 and rotates it around itself by 180° so as to lay the side wall 7 on the support plate 21 (the side wall 6, which is opposite the side wall 7, was previously resting on the support plate 21).

According to a preferred embodiment, in the handling station S5 there also is a removal unit 39, which, while the motor-driven arm 37 changes the position of the component 1 on the support plate 21, removes (eliminates) excess parts of the two opposite ends of the coil 14 (cut in the previous welding station S4).

Subsequently, the main conveyor 19 moves the carriage 20 (carrying one single component 1 in its own seat 22) along the winding path P and from the handling station S5 to the winding station S6, in which the carriage 20 stops and in which a winding unit 35 (completely identical to the winding unit 35 present in the winding station S3) winds an externally insulated conductor wire 15 around the component 1 carried by the carriage 20 in order to obtain a series of turns making up the coil 13.

Subsequently, the main conveyor 19 moves the carriage 20 (carrying one single component 1 in its own seat 22) along the winding path P and from the winding station S6 to the welding station S7 (arranged downstream of the winding station S6), in which the carriage 20 stops and in which the two opposite ends of the coils 13, which was wound in the previous winding station S6, are welded (for example, through ultrasounds, through heat sealing or through laser) to the two corresponding electrical contacts 8 by a welding unit 36 (completely identical to the welding unit 36 present in the welding station S4).

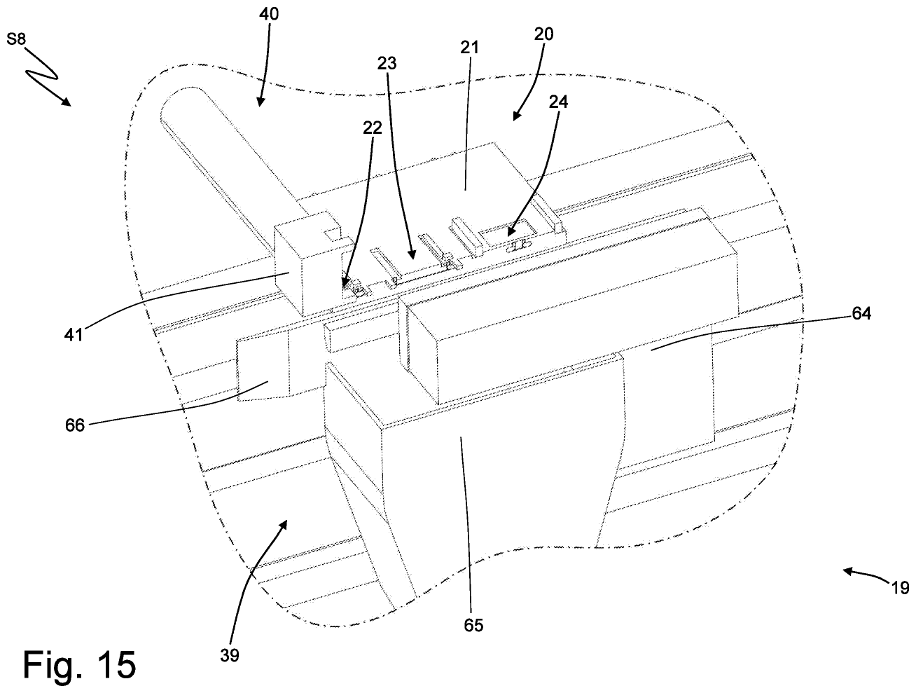

Subsequently, the main conveyor 19 moves the carriage 20 (carrying one single component 1 in its own seat 22) along the winding path P and from the welding station S7 to the handling station S8 (arranged downstream of the welding station S7), in which the carriage 20 stops and in which the component 1 is rotated by 90° in order to be placed in the seat 23 of the carriage 20 by laying the front wall 4 on the support plate 21 (namely, with the rear wall 5 arranged horizontally and in the highest point). According to FIG. 15, in the handling station S8 there is a motor-driven arm 40 provided with a holding head 41, which is designed to grab the component 1 leaving the front wall 4 completely free; when the carriage 20 is standing still in the handling station S8, the motor-driven arm 40 grabs the component 1 standing in the seat 22 of the carriage 20 and rotates it around itself by 90° so as to lay the front wall 4 on the support plate 21 and moving the component 1 from the seat 22 to the seat 23 (the component 1 was previously arranged in the seat 22 and the side wall 7 was previously resting on the support plate 21).

According to a preferred embodiment, in the handling station S8 there also is a removal unit 39 (completely identical to the removal unit 39 present in the handling station S5), which, while the motor-driven arm 40 changes the position of the component 1 on the support plate 21, removes (eliminates) excess parts of the two opposite ends of the coil 13 (cut in the previous welding station S7).

Subsequently, the main conveyor 19 moves the carriage 20 (carrying one single component 1 in its own seat 23) along the winding path P and from the handling station S8 to the winding station S9, in which the carriage 20 stops and in which a winding unit 35 (completely identical to the winding unit 35 present in the winding station S3) winds an externally insulated conductor wire 15 around the component 1 carried by the carriage 20 in order to obtain a series of turns making up the coil 12.

Subsequently, the main conveyor 19 moves the carriage 20 (carrying one single component 1 in its own seat 23) along the winding path P and from the winding station S9 to the welding station S10 (arranged downstream of the winding station S9), in which the carriage 20 stops and in which the two opposite ends of the coils 12, which was wound in the previous winding station S9, are welded (for example, through ultrasounds, through heat sealing or through laser) to the two corresponding electrical contacts 8 by a welding unit 36 (completely identical to the welding unit 36 present in the welding station S4).

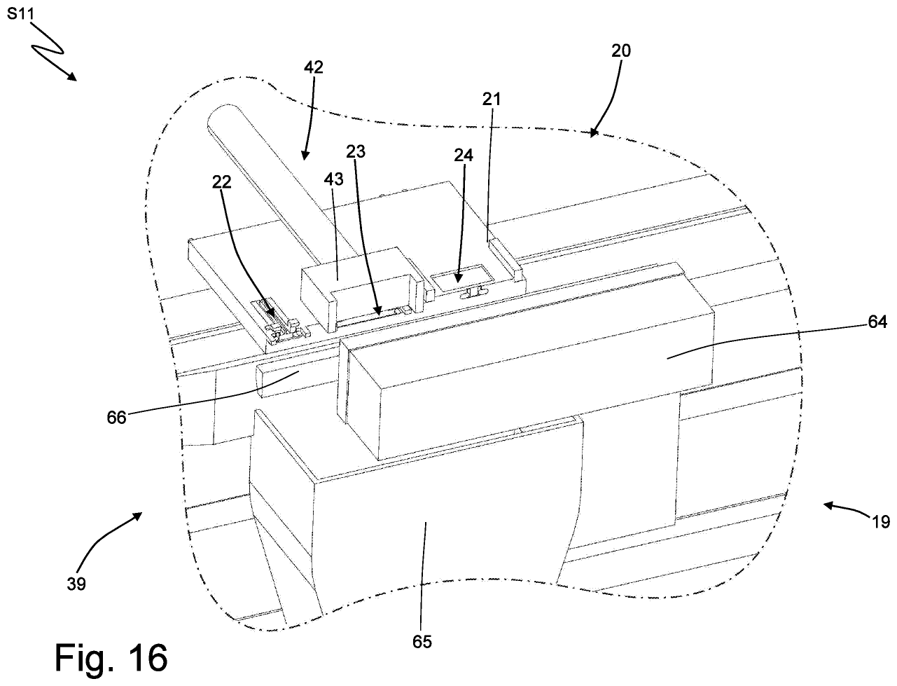

Subsequently, the main conveyor 19 moves the carriage 20 (carrying one single component 1 in its own seat 23) along the winding path P and from the welding station S10 to the handling station S11 (arranged downstream of the welding station S10), in which the carriage 20 stops and in which the component 1 is turned upside-down (namely, rotated around itself by 180°) in order to be placed in the seat 23 of the carriage 20 by laying the rear wall 5 on the support plate 21 (namely, with the front wall 4 arranged horizontally and in the highest point). According to FIG. 16, in the handling station S11 there is a motor-driven arm 42 provided with a holding head 43, which is designed to grab the component 1 leaving the walls 4 and 5 completely free; when the carriage 20 is standing still in the handling station S11, the motor-driven arm 40 grabs the component 1 standing in the seat 23 of the carriage 20 and rotates it around itself by 180° so as to lay the rear wall 5 on the support plate 21 (the front wall 4, which is opposite the rear wall 5, was previously resting on the support plate 21).

According to a preferred embodiment, in the handling station S11 there also is a removal unit 39 (completely identical to the removal unit 39 present in the handling station S5), which, while the motor-driven arm 42 changes the position of the component 1 on the support plate 21, removes (eliminates) excess parts of the two opposite ends of the coil 12 (cut in the previous welding station S10).

Subsequently, the main conveyor 19 moves the carriage 20 (carrying one single component 1 in its own seat 23) along the winding path P and from the handling station S11 to the winding station S12, in which the carriage 20 stops and in which a winding unit 35 (completely identical to the winding unit 35 present in the winding station S3) winds an externally insulated conductor wire 15 around the component 1 carried by the carriage 20 in order to obtain a series of turns making up the coil 11.

Subsequently, the main conveyor 19 moves the carriage 20 (carrying one single component 1 in its own seat 23) along the winding path P and from the winding station S12 to the welding station S13 (arranged downstream of the winding station S12), in which the carriage 20 stops and in which the two opposite ends of the coils 11, which was wound in the previous winding station S12, are welded (for example, through ultrasounds, through heat sealing or through laser) to the two corresponding electrical contacts 8 by a welding unit 36 (completely identical to the welding unit 36 present in the welding station S4).

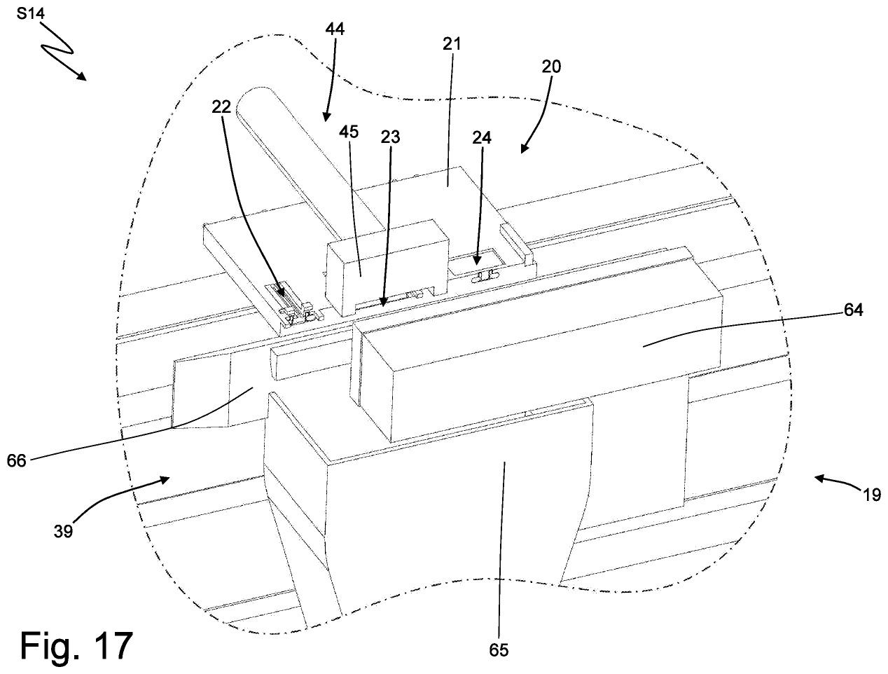

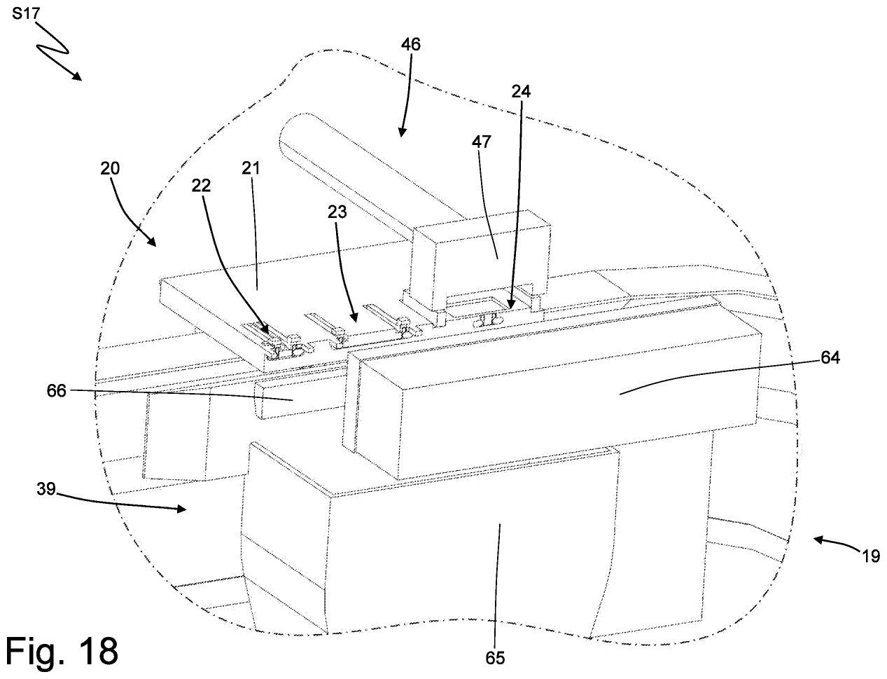

Subsequently, the main conveyor 19 moves the carriage 20 (carrying one single component 1 in its own seat 23) along the winding path P and from the welding station S13 to the handling station S14 (arranged downstream of the welding station S13), in which the carriage 20 stops and in which the component 1 is rotated by 90° in order to be placed in the seat 24 of the carriage 20 by laying the upper wall 2 on the support plate 21 (namely, with the lower wall 3 arranged horizontally and in the highest point). According to FIG. 17, in the handling station S14 there is a motor-driven arm 44 provided with a holding head 45, which is designed to grab the component 1 leaving the upper wall 2 completely free; when the carriage 20 is standing still in the handling station S14, the motor-driven arm 44 grabs the component 1 standing in the seat 23 of the carriage 20 and rotates it around itself by 90° so as to lay the upper wall 2 on the support plate 21 and moving the component 1 from the seat 23 to the seat 24 (the component 1 was previously located in the seat 23 and the rear wall 5 was previously resting on the support plate 21).

According to a preferred embodiment, in the handling station S14 there also is a removal unit 39 (completely identical to the removal unit 39 present in the handling station S5), which, while the motor-driven arm 44 changes the position of the component 1 on the support plate 21, removes (eliminates) excess parts of the two opposite ends of the coil 11 (cut in the previous welding station S13).

Subsequently, the main conveyor 19 moves the carriage 20 (carrying one single component 1 in its own seat 24) along the winding path P and from the handling station S14 to the winding station S15, in which the carriage 20 stops and in which a winding unit 35 (completely identical to the winding unit 35 present in the winding station S3) winds an externally insulated conductor wire 15 around the component 1 carried by the carriage 20 in order to obtain a series of turns making up the coil 10.

Subsequently, the main conveyor 19 moves the carriage 20 (carrying one single component 1 in its own seat 24) along the winding path P and from the winding station S15 to the welding station S16 (arranged downstream of the winding station S15), in which the carriage 20 stops and in which the two opposite ends of the coils 10, which was wound in the previous winding station S15, are welded (for example, through ultrasounds, through heat sealing or through laser) to the two corresponding electrical contacts 8 by a welding unit 36 (completely identical to the welding unit 36 present in the welding station S4).

Subsequently, the main conveyor 19 moves the carriage 20 (carrying one single component 1 in its own seat 24) along the winding path P and from the welding station S16 to the handling station S17 (arranged downstream of the welding station S16), in which the carriage 20 stops and in which the component 1 is turned upside-down (namely, rotated on itself by 180°) in order to be placed in the seat 24 of the carriage 20 by laying the lower wall 3 on the support plate 21 (namely, with the upper wall 2 arranged horizontally and in the highest point). According to FIG. 16, in the handling station S17 there is a motor-driven arm 46 provided with a holding head 47, which is designed to grab the component 1 leaving the upper wall 2 and the lower wall 3 completely free; when the carriage 20 is standing still in the handling station S17, the motor-driven arm 46 grabs the component 1 standing in the seat 24 of the carriage 20 and rotates it around itself by 180° so as to lay the lower wall 3 on the support plate 21 (the upper wall 2, which is opposite the lower wall 3, was previously resting on the support plate 21).

According to a preferred embodiment, in the handling station S17 there also is a removal unit 39 (completely identical to the removal unit 39 present in the handling station S5), which, while the motor-driven arm 46 changes the position of the component 1 on the support plate 21, removes (eliminates) excess parts of the two opposite ends of the coil 10 (cut in the previous welding station S16).

Subsequently, the main conveyor 19 moves the carriage 20 (carrying one single component 1 in its own seat 24) along the winding path P and from the handling station S17 to the winding station S18, in which the carriage 20 stops and in which a winding unit 35 (completely identical to the winding unit 35 present in the winding station S3) winds an externally insulated conductor wire 15 around the component 1 carried by the carriage 20 in order to obtain a series of turns making up the coil 9.

Subsequently, the main conveyor 19 moves the carriage 20 (carrying one single component 1 in its own seat 24) along the winding path P and from the winding station S15 to the welding station S19 (arranged downstream of the winding station S18), in which the carriage 20 stops and in which the two opposite ends of the coils 9, which was wound in the previous winding station S18, are welded (for example, through ultrasounds, through heat sealing or through laser) to the two corresponding electrical contacts 8 by a welding unit 36 (completely identical to the welding unit 36 present in the welding station S4).

Subsequently, the main conveyor 19 moves the carriage 20 (carrying one single component 1 in its own seat 24) along the winding path P and from the welding station S19 to the output station S2 (arranged downstream of the welding station S19), in which the carriage 20 stops and in which the component 1 is retrieved from the seat 24 in order to be directed towards an output of the machine 18. According to FIG. 4, in the output station S2 there is a motor-driven arm 48 provided with a holding head 49, which is designed to grab the component 1 in order to retrieve the component 1.

According to a preferred embodiment, in the output station S2 there also is a removal unit 39 (completely identical to the removal unit 39 present in the handling station S5), which, while the motor-driven arm 48 retrieves the component 1, removes (eliminates) excess parts of the two opposite ends of the coil 9 (cut in the previous welding station S19).

One single winding unit 35 will be described hereinafter, since all six winding units 35 are substantially identical to one another and operate all in the same way.

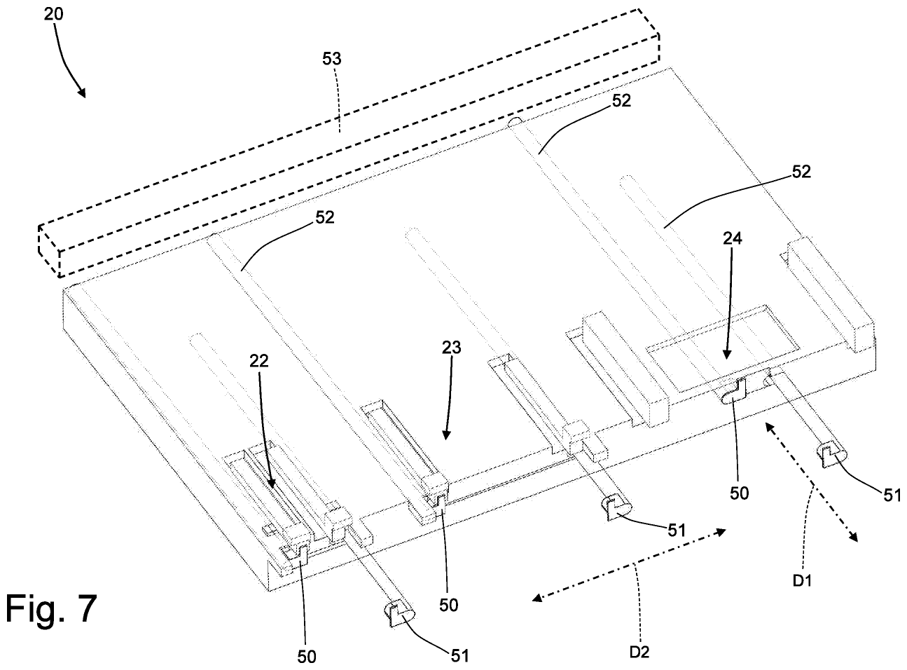

According to FIGS. 9-12, each carriage 20 comprises, for each seat 22, 23 or 24, two clamps 50 and 51 (better shown in FIG. 7), which are mounted on the support plate 21 under the seat 22, 23 or 24 and are arranged side by side. Each clamp 50 or 51 is designed to hold and lock a corresponding end of the wire 15 to be wound around the respective component 1 and is provided with one single movable jaw, which moves back and forth along a horizontal holding direction D1, which is perpendicular to the winding path P (shown in FIG. 7). In other words, each clamp 50 or 51 opens and closes by means of a movement developing along the holding direction D1 and, therefore, is perpendicular to the winding path P so that, by closing, the clamps 50 and 51 cause the wire 15 to come into contact with the corresponding electrical contacts 8. In particular, in use, the clamp 50 is used to grab an initial end of the wire 15 at the beginning of the winding of the wire 15 around the component 1 (i.e. before winding the wire 15 around the component 1, its initial end is grabbed by the clamp 50); on the other hand, in use, the clamp 51 is used to grab a final end of the wire 15 at the end of the winding of the wire 15 around the component 1 (i.e. after having completed the winding of the wire 15 around the component 1, its final end is grabbed by the clamp 51).

The movable jaw of each clamp 50 or 51 is moved along the holding direction D1 by means of a control rod 52 (shown in FIG. 7), which is arranged through the support plate 21 and comes out from the back of the support plate 21 in order to be pushed by and actuator device 53 (shown in FIG. 7) located in a fixed position (namely, mounted on the frame of the machine 18) in the area of each winding unit 35 (namely, in the area of each winding station S3, S6, S9, S12, S15, S18). Preferably, each clamp 50 or 51 normally is closed, namely, in the absence of an intervention of the actuator device 53, it naturally remains closed; this result is obtained thanks to the presence of a spring, which tends to push the movable jaw of each clamp 50 or 51 towards the closed position and is compressed by the action of the actuator device 53 (namely, the actuator device 53 must overcome the elastic force generated by the spring in order to move the movable jaw of each clamp 50 or 51 towards the open position).

In each winding unit 35 there are two clamps 54 and 55, which are mounted (on the frame of the machine 18 and, hence, on the outside of the main conveyor 19, so as not to move together with the carriages 20) under the support plates 21 of the carriages 20 and are arranged next to one another; in particular, the pair of clamps 54 and 55 is vertically aligned with a corresponding pair of clamps 50 and 51 carried by a carriage 20, which stops in the area of the winding unit 35.

Each clamp 54 or 55 is designed to hold and lock a corresponding end of the wire 15 to be wound around the respective component 1 and is provided with one single movable jaw, which moves back and forth along a horizontal holding direction D2, which is parallel to the winding path P (namely, perpendicular to the holding direction D1 and shown in FIG. 7). In other words, each clamp 54 or 55 opens and closes by means of a movement developing along the holding direction D2 and, therefore, is parallel to the winding path P. According to a preferred embodiment shown in the accompanying figures, the clamps 54 and 55 share a common jaw without movement arranged between the clamps 54 and 55.

In particular, in use, the clamp 54 is used to grab the initial end of the wire 15 at the beginning of the winding of the wire 15 around the component 1 and (immediately) before the initial end of the wire 15 is grabbed by the clamp 50 above; on the other hand, in use, the clamp 55 is used to grab the final end of the wire 15 at the end of the winding of the wire 15 around the component 1 and (immediately) after the final end of the wire 15 is grabbed by the clamp 51 above.

Preferably, each clamp 54 or 55 normally is closed, namely, in the absence of an intervention of an actuator device, it naturally remains closed; this result is obtained thanks to the presence of a spring, which tends to push the movable jaw of each clamp 54 or 55 towards the closed position and is compressed by the action of the actuator device (namely, the actuator device must overcome the elastic force generated by the spring in order to move the movable jaw of each clamp 54 or 55 towards the open position).

Each winding unit 35 comprises a blade 56, which is mounted (on the frame of the machine 18 and, hence, on the outside of the main conveyor 19 so as not to move together with the carriages 20) under the support plates 21 of the carriages 20 in order to be, in use, between a respective clamp 51 carried by a carriage 20 and a respective clamp 55.

Each blade 56 is, in use, movable along a cutting direction coinciding with the holding direction D2 (shown in FIG. 7), namely each blade 56 moves back and forth by means of a movement parallel to the winding path P. Thanks to its position, each movable blade 56 can cut a final end of a wire 15, which is locked higher by a respective clamp 51 carried by a carriage 20, and is locked lower by a respective clamp 55.

Each winding unit 35 comprises a movable finger 57, which is used to bring the wire 15 close to the component 1 in order to wind the wire 15 around the component 1 and, hence, move the wire 15 away from the component 1. Each movable finger 57 has a tubular shape having a central hole going through the movable finger 57 from side to side and accommodating the wire 15; namely, the wire 15 is inserted into a rear opening of the movable finger 57 and comes out from a front opening of the movable finger 57. For each movable finger 57, the wire 15 is progressively unwound from a reel contained in a suitable container, goes through a stretching device provided with at least one movable dandy roller operated by a spring and, then, reaches the movable finger 57; each stretching device is configured to apply an always constant stretch to the wire 15.

The winding unit 35 comprises a common support body 58 (shown in FIG. 9), on which the movable finger 57 is mounted in order to move the movable finger 57; in particular, the movable finger 57 is mounted on the support body 58 in a rigid manner, namely the movable finger 57 always moves with the support body 58 in an integral manner and never makes any kind of movement relative to the support body 58. The support body 58 is moved by one single actuator device 59 (schematically shown in FIG. 9) provided with (at least) an independent electric motor of its own. In use, each movable finger 57 is placed with a horizontal orientation when the wire 15 has to be vertically moved in order to go up getting close to the component 1 or in order to go down moving away from the component 1; furthermore, in use, each movable finger 57 is placed with a vertical orientation when the wire 15 has to be horizontally moved in order be wound around the component 1.

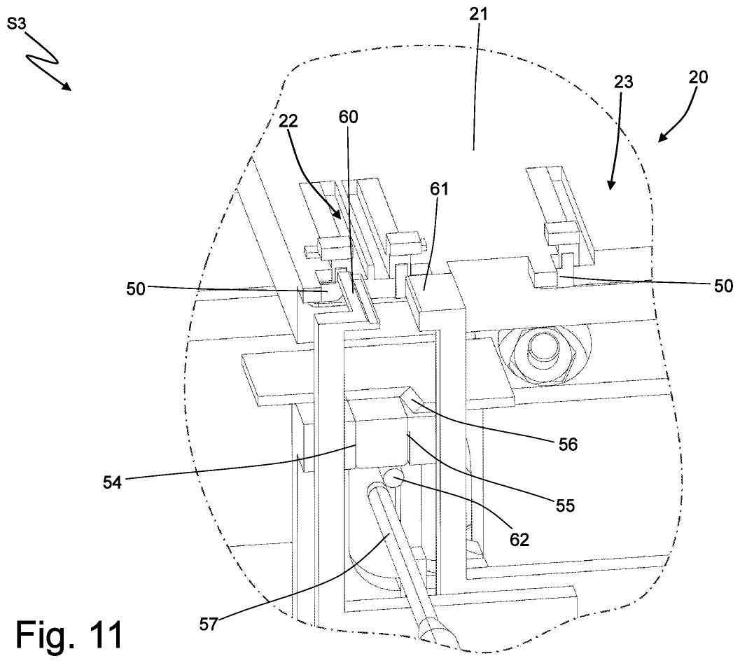

Each winding unit 35 comprises a containing body 60 (better shown in FIG. 11), which, in use, is laid against the pin 16 so as to extend the pin 16 when the wire 15 has to be bent around the pin 16 in order to prevent the wire 15 from accidentally slipping away from the pin 16; namely, shortly before the wire 15 is bent by 90° around the pin 16, the containing body 60 is laid against the pin 16 in order to extend the pin 16, thus preventing the wire 15 from accidentally slipping away from the pin 16. To this regard, it should be pointed out that the pin 16 cannot be too large (due to space problems that are not related to the machine 18) and, at the same time, the movable finger 57 cannot get too close to the component 1 when moving in order to prevent small positioning errors (together with constructive tolerances of the component 1) from causing accidental hits of the movable finger 57 against the component 1.

Each winding unit 35 comprises a containing body 61 (better shown in FIG. 11), which, in use, is laid against the pin 17 so as to extend the pin 17 when the wire 15 has to be bent around the pin 17 in order to prevent the wire 15 from accidentally slipping away from the pin 17; namely, shortly before the wire 15 is bent by 90° around the pin 17, the containing body 61 is laid against the pin 17 in order to extend the pin 17, thus preventing the wire 15 from accidentally slipping away from the pin 17. To this regard, it should be pointed out that the pin 17 cannot be too large (due to space problems that are not related to the machine 18) and, at the same time, the movable finger 57 cannot get too close to the component 1 when moving in order to prevent small positioning errors (together with constructive tolerances of the component 1) from causing accidental hits of the movable finger 57 against the component 1.

According to a preferred embodiment shown in the accompanying figures, each winding unit 35 comprises a further movable finger 62 (better shown in FIG. 11), which is arranged under the two clamps 54 and 55 and between the two clamps 54 and 55 (namely, under the common jaw without movement arranged between the clamps 54 and 55) and is vertically moved in order to remove the initial end of the wire 15, which can remain inside the clamp 55 even when the clamp 55 is opened (the initial end of the wire 15 is very light and, hence, it often does not manage to naturally remove itself from the clamp 55 due to gravity); in this way, namely, thanks to the removing action exerted by the movable finger 62, the initial end of the wire 15 is prevented from remaining inside the clamp 55 in an undesired manner, thus breaking due to tearing when the carriage 20 moves at the end of the winding. In particular, the clamp 55 is opened after the initial end of the wire 15 has been engaged by the clamp 54 in order to begin a new winding and, at this point, the movable finger 62 makes a vertical downward work stroke to remove the initial end of the wire 15 from the clamp 55.

The winding of a wire 15 around a component 1 in one single winding unit 35 will be described below; obviously, the operations carried out in one single winding unit 35 are simultaneously carried out—in the exact same manner—also in the other winding units 35.

At first, the winding unit 35 is empty (namely, lacks the component 1 carried by a carriage 20), an initial end of the wire 15 is locked in the clamp 55 and the movable finger 57 (arranged horizontally) is under the clamp 55. The initial end of the wire 15 locked in the clamp 55 is the initial end with reference to the new winding that has to be performed around the next component 1 that is about to reach the winding unit 35, while, on the other hand, it was the final end of the wire 15 with reference to the previous winding that was completed around the previous component 1 that was previously located in the winding unit 35. When the machine 18 is started after a replacement of the reels from which the wire 15 is unwound, an operator manually places the initial end of the wire 15 in the clamp 55.

Subsequently, the carriage 20 moves the component 1 to the winding unit 35, the clamps 50 and 54 open, the movable finger 57 (still arranged horizontally) vertically moves from the bottom to the top in order to cause the initial end of the wire 15 to go, at first, through the clamp 54 and, subsequently, through the clamp 50 and, finally, the clamps 54 and 50 close in order to lock (in two different points) the initial end of the wire 15; preferably, the sole clamp 54 closes at first, while the clamp 50 is still open and, subsequently, the clamp 50 closes as well. It should be pointed out that the clamp 50 opens and closes by means of a movement along the holding direction D1, which is perpendicular to the winding path P, and, hence, in the closing movement, the clamp 50 moves the wire 15 perpendicular to the winding path P by pulling the wire 15 against the component 1 so that the wire 15 rests on a corresponding electrical contact 8.

Subsequently, the movable finger 57 rotates by 90° so as to move from a horizontal orientation to a vertical orientation and starts to rotate around the component 1 in order to wind the wire 15 around the component 1. Before starting to wind the wire 15 around the component 1, the wire 15 vertically going up towards the component 1 is bent by the movable finger 57 around the pin 16, which horizontally projects from the component 1, in order to cause the wire 15 to make a 90° turn, which deflects the wire 15 towards a horizontal orientation. In particular, the 90° rotation of the movable finger 57 moving from a horizontal orientation to a vertical orientation takes place simultaneously with the bending of the wire 15 around the pin 16. As mentioned above, in this step, the containing body 60 is laid against the pin 16 in order to extend the pin 16 when the wire 15 has to be bent around the pin 16, thus preventing the wire 15 from accidentally slipping away from the pin 16.

Subsequently, the movable finger 57 makes a series of laps around the component 1 in order to obtain, with the wire 15, a series of (vertically staggered) turns around the component 1.

Approximately when the wire 15 starts to be wound around the component 1, the clamp 55 opens and the movable finger 62 makes a vertical downward work stroke to remove the initial end of the wire 15 from the clamp 55.

When the winding of the wire 15 around the component 1 is almost complete (namely, before ending the last turn of the winding), the containing body 60 is moved away from the component 1 and (preferably) the clamp 54 is opened to free the initial end of the wire 15 (while the clamp 50 remains closed).

After having ended winding the wire 15 around the component 1, the movable finger 57 bends the horizontally arranged wire 15 around the pin 17 in order to cause the wire 15 to make a 90° turn, which deflects the wire 15 towards a vertical orientation.

Simultaneously with the bending of the wire 15 around the pin 17, the movable finger 57 rotates by 90° in order to move from a vertical orientation to a horizontal orientation. As mentioned above, in this step, the containing body 61 is laid against the pin 17 in order to extend the pin 17 when the wire 15 has to be bent around the pin 17, thus preventing the wire 15 from accidentally slipping away from the pin 17.

When the end of the winding of the wire 15 around the component 1 is close (namely, before completing the last turn of the winding), the pin 51 is opened. The movable finger 57, by vertically moving the wire 15 from the top to the bottom after having bent the wire 15 around the pin 17, causes the final end of the wire 15 to go through the open clamp 51, which closes immediately after, hence locking the final end of the wire 15; subsequently, the movable finger 57, by vertically moving the wire 15 from the top to the bottom after having bent the wire 15 around the pin 17, causes the final end of the wire 15 to also go through the open clamp 55, which closes immediately after, hence locking the final end of the wire 15. It should be pointed out that the clamp 51 opens and closes by means of a movement along the holding direction D1, which is perpendicular to the winding path P, and, hence, in the closing movement, the clamp 51 moves the wire 15 perpendicular to the winding path P by pulling the wire 15 against the component 1 so that the wire 15 rests on a corresponding electrical contact 8.

Subsequently, the containing body 61 moves away from the component 1 and the winding manufacturing process ends with the movement of the movable blade 56, which, by moving parallel to the winding path P, cuts the final end of the wire 15 after the final end of the wire 15 has been locked both by the clamp 51 and by the clamp 55 (namely, the movable blade 56 cuts the final end of the wire 15 between the portion locked higher by the clamp 51 and the portion locked lower by the clamp 55).

According to a possible embodiment, the winding of the wire 15 around the component 1 is carried out from the bottom to the top; hence, before starting the winding of the wire 15, the wire 15 vertically going up towards the component 1 is bent around the pin 16 (arranged lower) in order to cause the wire 15 to make a 90° turn, which deflects the wire 15 towards a horizontal orientation; furthermore, after having ended the winding of the wire 15, the horizontally arranged wire 15 is bent around the pin 17 (arranged higher) in order to cause the wire 15 to make a 90° bend, which deflects the wire 15 towards a vertical orientation. According to a different embodiment, the winding of the wire 15 around the component 1 is carried out from the top to the bottom; hence, before starting the winding of the wire 15, the wire 15 vertically going up towards the component 1 is bent around the pin 16 (arranged higher) in order to cause the wire 15 to make a 90° turn, which deflects the wire 15 towards a horizontal orientation; furthermore, after having ended the winding of the wire 15, the horizontally arranged wire 15 is bent around the pin 17 (arranged lower) in order to cause the wire 15 to make a 90° bend, which deflects the wire 15 towards a vertical orientation. In this embodiment, the winding of the wire 15 around the component 1 takes place above a vertical segment of the wire 15 reaching the pin 16 (arranged higher) and, hence, helps lock the initial end of the wire 15 against the component 1, ensuring a greater stability of the winding.

According to FIG. 13, the welding station S4 comprises a corresponding welding unit 36, which is arranged in a fixed position (namely, does not move together with the main conveyor 19) and is provided with a movable welding head 63 to get close to the component 1 carried by a carriage 20 standing still in the welding station S4 so as to weld the two ends of the wire 15 to the corresponding electrical contacts 8 and, subsequently, move away from the component 1 carried by the carriage 20 once the welding has ended. The movement of the welding head 63 always is linear and can be oriented vertically (which is the case in the welding stations S4, S7, S10 and S13) or can be oriented horizontally (which is the case in the welding stations S16 and S19) depending on the orientation assumed by the component 1. The welding head 63 is provided with two welding elements next to one another to simultaneously weld both ends of the wire 15 to the corresponding electrical contacts 8. Preferably, the welding head 63 is also configured to cut the two ends of the wire 15 downstream of the welds to the two electrical contacts 8, so as to separate the excess part of the two opposite ends of the coil 9-14; namely, the welding head 63 is also provided with blades, which cut the wire 15 downstream of the welds to the two electrical contacts 8.

As mentioned above, in all six welding stations S4, S7, S10, S13, S16 and S19, the corresponding six welding units 36 are substantially identical to one another and the only significant change lies in the vertical orientation of the welding heads 63 in the welding stations S4, S7, S10 and S13 and in the horizontal orientation of the welding heads 63 in the welding stations S16 and S19 to adjust to the different orientations of the components 1.

According to FIG. 14, the handling station S5 comprises a corresponding removal unit 39 provided with a blower device 64, which is connected to a common compressed air distributor and is configured to generate a compressed air blow, which is directed from the top to the bottom and hits a corresponding component 1 carried by a carriage 20 standing still in the removal station S5. The compressed air blow hits from the top to the bottom a corresponding component 1 carried by a carriage 20 standing still in the removal station S5 and, then, pushes downwards the excess parts of the two opposite ends of the coil 9-14 (cut in the previous welding station S4); preferably, the excess parts of the two opposite ends of the coil 9-14 pushed downwards by a compressed air blow are collected in a container 65 located under the carriage 20. According to a preferred embodiment, the removal unit 39 also comprises a clamp 66, which is arranged in a fixed position (namely, on the outside of the main conveyor 19) under the support plate 21 of a carriage 20 standing still and grabs the excess parts of the two opposite ends of the coil 9-14 while waiting for the excess parts to be directed into the container 65 by the air blows.

As mentioned above, in all five handling stations S5, S8, S11, S14, S17 and S19 and in the output station S2, the corresponding six removal units 39 are substantially identical to one another.

In the embodiment described above, in the five handling stations S5, S8, S11, S14, S17 and S19, each component 1 is rotated by 90° or 180° around a horizontal rotation axis; according to other embodiments, in one or more handling stations S5, S8, S11, S14, S17 and S19, each component 1 is rotated around several different rotation axes: for example, each component 1 is rotated at first by 90° or 180° (or even by a different angle, such as 45°, 75° or others) around a horizontal rotation axis and then is rotated by 90° or 180° (or even by a different angle, such as 45°, 75° or others) around a vertical rotation axis.

In the non-limiting embodiment described above, the component 1 is part of a disposable cartridge of an electronic cigarette, but the method to manufacture coils 9-14 described above can also be applied to the production of components for articles of any type (namely, of any product class). For example, the method to manufacture coils 9-14 described above can be applied to the production of components for a machine, a plant, a construction, for example, but not exclusively, of the tobacco, pharmaceutical, food-related or entertainment industry; more in general, the method to manufacture coils 9-14 described above can be applied to the production of components for applications of any type.

The embodiments described herein can be combined with one another, without for this reason going beyond the scope of protection of the invention.

The method to manufacture coils 9-14 described above have numerous advantages.

First of all, the method to manufacture coils 9-14 described above allows for an operation at a high operating speed (measured as number of components produced per time unit).

Furthermore, the method to manufacture coils 9-14 described above maintains a high productive quality (generally measured as percentage of faulty pieces).

Finally, the method to manufacture coils 9-14 described above is relatively simple and economic to be implemented.

1. A method to manufacture at least two different coils (9-14) around a component (1) of an article; the method comprises the steps of:
moving, by means of a main conveyor (19) and along a winding path (P), a carriage (20) carrying at least one seat (22, 23, 24) designed to house the component (1); placing, in an input station (SI) arranged along the winding path (P), the component (1) in the seat (22, 23, 24) of the carriage (20);
winding, in a first winding station (S3) arranged along the winding path (P) downstream of the input station (SI), a first externally insulated conductor wire (15) around the component (1) in order to obtain a series of turns making up a first coil (9-14); and winding, in a second winding station (S6) arranged along the winding path (P) downstream of the first winding station (S3), a second externally insulated conductor wire (15) around the component (1) in order to obtain a series of turns making up a second coil (9-14); and
changing, in a first handling station (S5) arranged along the winding path (P) between the first winding station (S3) and the second winding station (S6), the orientation of the component (1) relative to the carriage (20).

2. The method according to claim 1, wherein, in the first handling station (S5), the component is rotated by 90° or 180°.

3. The method according to claim 1, wherein the carriage (20) has at least two different seats (22, 23, 24) next to one another, each designed to house the component (1) with a different orientation.

4. The method according to claim 3, wherein, in the first handling station (S5), the component is rotated by 90° or 180°, and is also moved from a first seat (22, 23, 24) to a second seat (22, 23, 24).

5. The method according to claim 4, wherein, in the first handling station (S5), the component (1) remains in the same seat (22, 23, 24) when it is rotated by 180° and, on the other hand, is moved from the first seat (22, 23, 24) to the second seat (22, 23, 24) when it is rotated by 90°.

6. The method according to claim 1 and comprising the further steps of:
changing, in one or more second handling stations (S8, S 11, S 14, S 17) arranged along the winding path (P) downstream of the second winding station (S6), the orientation of the component (1) relative to the carriage (20); and
winding, in one or more third winding stations (S9, S12, S15, S 18) arranged along the winding path (P) downstream of corresponding second handling stations (S8, Si I, S14, S17), one or more third externally insulated conductor wires (15) around the component (1) in order to obtain a series of turns making up one or more third coils (9-14).

7. The method according to claim 1 and comprising the further steps of:
welding, in a first welding station (S4) arranged along the winding path (P) downstream of the first winding station (S3), two opposite ends of the first coil (9-14) to two corresponding electrical contacts (8) of the component (1); and
welding, in a second welding station (S7) arranged along the winding path (P) downstream of the second winding station (S6), two opposite ends of the second coil (9-14) to two corresponding electrical contacts (8) of the component (1).

8. The method according to claim 1, wherein winding a wire (15) comprises the further steps of:
locking an initial end of the wire (15) by means of a first clamp (50) before starting to wind the wire (15); and
locking a final end of the wire (15) by means of a second clamp (51) at the end of the winding of the wire (15).

9. The method according to claim 8, wherein the first clamp (50) and the second clamp (51) are carried by a support plate (21) of the carriage (20), where the seats (22, 23, 24) are defined, and are arranged under the seat (22, 23, 24).

10. The method according to claim 8, wherein the first clamp (50) and the second clamp (51) open and close by means of a movement that is perpendicular to the winding path (P), so that, by closing, they cause the wire (15) to come into contact with corresponding electrical contacts (8) of the component (1).

11. The method according to claim 8, wherein winding the wire (15) comprises the further steps of:
locking, before locking the initial end of the wire (15) by means of the first clamp (50), the initial end of the wire (15) also by means of a third clamp (54), which is arranged in a fixed position on the outside of the main conveyor (19) and is aligned with the first clamp (50); and
locking, after having locked the final end of the wire (15) by means of the second clamp (51), the final end of the wire (15) also by means of a fourth clamp (55), which is arranged next to the third clamp (54) in a fixed position on the outside of the main conveyor (19) and is aligned with the second clamp (51).

12. The method according to claim 11, wherein the third clamp (54) and the fourth clamp (55) open and close by means of a movement that is parallel to the winding path (P).

13. The method according to claim 12, wherein the third clamp (54) and the fourth clamp (55) share a common jaw without movement arranged between the third clamp (54) and the fourth clamp (55).

14. The method according to claim 11, wherein winding the wire (15) comprises the further steps of:
opening the fourth clamp (55) when the winding of the wire (15) around the component (1) has begun; and
vertically moving downward a first movable finger (62), which is arranged under the third clamp (54) and the fourth clamp (55), so as to remove an initial end of the wire (15) from the open fourth clamp (55).

15. The method according to claim 11, wherein winding the wire (15) comprises the further step of cutting, by means of a movable blade arranged between the second clamp (51) and the fourth clamp (55), the final end of the wire (15) after the final end of the wire (15) has been locked both by the second clamp (51) and by the fourth clamp (55).

16. The method according to claim 11, wherein winding a wire (15) comprises the further step of moving the wire (15) by means of a second movable finger (57), which engages the wire (15) in a sliding manner.

17. The method according to claim 16, wherein the second movable finger (57) has a tubular shape having a central hole, which goes through the second movable finger (57) from side to side and inside which the wire (15) is arranged.

18. The method according to claim 16, wherein winding the wire (15) comprises the further steps of:
placing the second movable finger (57) with a horizontal orientation when the wire (15) has to be vertically moved in order to go up getting close to the component (1) or in order to go down moving away from the component (1); and
placing the second movable finger (57) with a vertical orientation when the wire (15) has to be horizontally moved in order be wound around the component (1).

19. The method according to claim 1, wherein winding a wire (15) comprises the further steps of:
bending, before starting to wind the wire (15), the wire (15) vertically going up towards the component (1) around a first pin (16), which horizontally projects from the component (1), in order to cause the wire (15) to make a turn, which deflects the wire (15) towards a horizontal orientation; and
bending, after having ended winding the wire (15), the horizontally arranged wire (15) around a second pin (17), which horizontally projects from the component (1), in order to cause the wire (15) to make a turn, which deflects the wire (15) towards a vertical orientation.

20. The method according to claim 19, wherein winding the wire (15) comprises the steps of:
laying a first containing body (60) against the first pin (16) so as to extend the first pin (16) before bending the wire (15) around the first pin (16); and
laying a second containing body (61) against the second pin (17) so as to extend the second pin (17) before bending the wire (15) around the second pin (17).

21. The method according to claim 1, wherein the main conveyor (19) comprises:
an annular guide (28);
a slide (29), which is coupled to the guide (28) so as to freely slide along the guide (28) and supports the carriage (20); and
a linear electric motor (30), which moves the slide (29) and is provided with an annular stator (31), which is arranged in a fixed position along the guide (28), and with a movable slider (32), which is electromagnetically coupled to the stator (31) so as to receive, from the stator (31), a driving force and is rigidly connected to the slide (29).

22. A machine (18) to manufacture at least two different coils (9-14) around a component (1) of an article; the machine (18) comprises:
a main conveyor (19), which is designed to move, along a winding path (P),
a carriage (20) carrying at least one seat (22, 23, 24) designed to house the component (1);
an input station (SI), which is arranged along the winding path (P) and is configured to place the component (1) in the seat (22, 23, 24) of the carriage (20);
a first winding station (S3), which is arranged along the winding path (P) downstream of the input station (SI) and is configured to wind a first externally insulated conductor wire (15) around the component (1) in order to obtain a series of turns making up a first coil (9-14); and
a second winding station (S6), which is arranged along the winding path (P) downstream of the first winding station (S3) and is configured to wind a second externally insulated conductor wire (15) around the component (1) in order to obtain a series of turns making up a second coil (9-14); and
a handling station (S5), which is arranged along the winding path (P) between the first winding station (S3) and the second winding station (S6) and is configured to change the orientation of the component (1) relative to the carriage (20).
